(19) United States
(12) Patent Application Publication
(10) Pub. No.: US 2023/0309155 A1
(43) Pub. Date: Sep. 28, 2023

(54) METHODS AND APPARATUS FOR RADIO CONNECTION

(71) Applicant: Telefonaktiebolaget LM Ericsson (publ), Stockholm (SE)

(72) Inventors: Zhang ZHANG, Beijing (CN); Antonio ORSINO, Kirkkonummi (FI); Congchi ZHANG, Shanghai (CN)

(73) Assignee: Telefonaktiebolaget LM Ericsson (publ), Stockholm (SE)

(21) Appl. No.: 18/018,527

(22) PCT Filed: Jul. 30, 2021
(86) PCT No.: PCT/CN2021/109445

§ 371 Date: Jan. 27, 2023

(30) Foreign Application Priority Data
Jul. 31, 2020 (WO) PCT/CN2020/106282

(51) Int. Cl. H04W 76/10; H04W 24/10

(52) U.S. Cl. CPC H04W 76/10; H04W 24/10

(57) ABSTRACT

Various embodiments of the present disclosure provide a method for radio connection. The method which may be performed by a first terminal device comprises determining first information about whether to set up a connection over a direct path between the first terminal device and a target network node in a communication network. The method further comprises transmitting the first information towards a first network node via a second terminal device. In accordance with an exemplary embodiment, the target network node may be the first network node or a second network node different from the first network node in the communication network.

### FIELD OF THE INVENTION

The present disclosure generally relates to communication networks, and more specifically, to a method and apparatus for radio connection.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the evolution of wireless communication, a requirement for supporting device-to-device (D2D) communication features in various applications is proposed. An extension for the D2D work may consist of supporting vehicle-to-everything (V2X) communication, which may include any combination of direct communications among vehicles, pedestrians and infrastructure. Wireless communication networks such as fourth generation (4G)/long term evolution (LTE) and fifth generation (5G)/new radio (NR) networks may be expected to use V2X services and support communication for V2X capable user equipment (UE).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a wireless communication network, V2X services may be used by various applications to meet different communication requirements. Direct unicast transmission over a sidelink (SL) between two V2X capable UEs (also called V2X UEs for short) may be needed in some applications such as platooning, cooperative driving, dynamic ride sharing, etc. For a remote UE in the network (NW), e.g., a UE that may be out of cell coverage and may not be able to connect with a network node directly, a UE-to-NW relay UE may provide the functionality to support connectivity to the NW for the remote UE. In this case, uplink/downlink (UL/DL) traffics of the remote UE may be forwarded by the UE-to-NW relay UE. When the remote UE in radio resource control (RRC) idle/inactive mode wants to establish/resume an RRC connection over a direct path to the NW, it may need to first start a random access procedure to access to the NW. Currently only contention based random access can be adopted for the UE not in RRC connected mode, which may increase the latency in RRC connection establishment/resumption. Therefore, it may be desirable to establish/resume an RRC connection over the direct path for the remote UE more quickly.

Various exemplary embodiments of the present disclosure propose a solution for radio connection, which can enable fast RRC connection establishment/resumption over a direct path for a remote UE, e.g. with the help of a UE-to-NW relay UE, so that the remote UE may access to the NW directly without performing a contention based random access procedure, and thus the latency in RRC connection establishment/resumption may be reduced significantly and the end user experience may also be improved.

It can be appreciated that the term “direct path” described in this document may refer to a path between a UE (e.g., a remote UE or a relay UE) and a network node (e.g. a base station, etc.) without via SL or any other types of relaying links.

It can be appreciated that the “remote UE” described in this document may refer to a UE that may communicate with a relay UE via PC5/SL interface, and/or communicate with a network node via Uu interface. As an example, the remote UE may be a 5G proximity services (ProSe) enabled UE that may communicate with a data network (DN) via a 5G ProSe UE-to-NW relay as defined in the 3rd generation partnership project (3GPP) technical specification (TS) 23.752 V0.4.0, where the entire content of this technical specification is incorporated into the present disclosure by reference.

It also can be appreciated that the “UE-to-NW relay UE” described in this document may also be referred to as “UE-to-Network relay UE”, “UE-to-Network relay”, “UE-to-NW relay”, “relay UE” or “relay” that is capable of supporting connectivity to the NW for other UE(s). As an example, the UE-to-NW relay UE may be a 5G ProSe UE-to-NW relay as defined in 3GPP TS 23.752 V0.4.0. The terms “UE-to-NW relay UE”, “UE-to-Network relay UE”, “UE-to-Network relay”, “UE-to-NW relay”, “relay UE” and “relay” may be used interchangeably in this document.

In addition, it can be appreciated that “set up a connection” mentioned in this document may refer to “establish/resume a connection”. Similarly, it also can be appreciated that the “connection setup” mentioned in this document may refer to “connection establishment/resumption”. Thus, it can be appreciated that establishing/resuming an RRC connection for a UE not in RRC connected mode may also be referred to as setting up an RRC connection for a UE not in RRC connected mode.

According to a first aspect of the present disclosure, there is provided a method performed by a first terminal device such as a UE. The method comprises: determining first information about whether to set up a connection over a direct path between the first terminal device and a target network node in a communication network. In accordance with an exemplary embodiment, the method further comprises: transmitting the first information towards a first network node via a second terminal device. The target network node may be the first network node or a second network node different from the first network node in the communication network.

In accordance with an exemplary embodiment, the first information may comprise a decision made by the first terminal device about whether to set up the connection over the direct path.

In accordance with an exemplary embodiment, the first information may indicate to set up the connection over the direct path between the first terminal device and the target network node.

In accordance with an exemplary embodiment, the first information may comprise first measurement information of the direct path between the first terminal device and the first network node. Alternatively or additionally, the first information may comprise second measurement information of a path between the first terminal device and the second terminal device. Alternatively or additionally, the first information may comprise third measurement information of one or more direct paths between the first terminal device and one or more network nodes different from the first network node.

In accordance with an exemplary embodiment, the first information may be determined based at least in part on one or more of:
first measurement configuration information which may be generated by the first network node and transmitted to the first terminal device via the second terminal device;
second measurement configuration information which may be stored at the second terminal device and transmitted to the first terminal device; and
third measurement configuration information which may be generated by the second terminal device and transmitted to the first terminal device.

In accordance with an exemplary embodiment, the method according to the first aspect of the present disclosure may further comprise: receiving, from the first network node via the second terminal device, second information about whether the connection over the direct path is to be set up for the first terminal device.

In accordance with an exemplary embodiment, the second information may comprise a decision made by the first network node about whether the connection over the direct path is to be set up for the first terminal device.

In accordance with an exemplary embodiment, the second information may indicate to set up the connection over the direct path between the first terminal device and the target network node.

In accordance with an exemplary embodiment, the first information may be transmitted towards the first network node via the second terminal device, when the first terminal device has traffic towards the communication network.

In accordance with an exemplary embodiment, the method according to the first aspect of the present disclosure may further comprise: transmitting, to the first network node via the second terminal device, a notification that the first terminal device has traffic towards the communication network.

In accordance with an exemplary embodiment, the second terminal device may be operated in RRC connected mode according to one or more of:
an indication from the first terminal device to indicate that a message of the first terminal device needs to be relayed by the second terminal device;
a service being relayed to the communication network by the second terminal device; and
one or more terminal devices being linked with the second terminal device and having traffic towards the communication network.

In accordance with an exemplary embodiment, the method according to the first aspect of the present disclosure may further comprise: receiving, from the first network node via the second terminal device, configuration information (e.g., resource information, etc.) for setting up the connection over the direct path for the first terminal device.

In accordance with an exemplary embodiment, the configuration information may include a radio network temporary identity (RNTI) for the first terminal device over the direct path. In an embodiment, the RNTI may be a cell-radio network temporary identity (C-RNTI) for the first terminal device over the direct path.

In accordance with an exemplary embodiment, the method according to the first aspect of the present disclosure may further comprise: obtaining an uplink grant configured to the first terminal device by the target network node, according to the configuration information.

In accordance with an exemplary embodiment, the method according to the first aspect of the present disclosure may further comprise: setting up the connection over the direct path between the first terminal device and the target network node, based at least in part on the uplink grant.

In accordance with an exemplary embodiment, the configuration information may indicate a contention free random access preamble and/or resource for the first terminal device over the direct path.

In accordance with an exemplary embodiment, the method according to the first aspect of the present disclosure may further comprise: performing contention free random access towards the target network node over the direct path, according to the configuration information.

In accordance with an exemplary embodiment, the method according to the first aspect of the present disclosure may further comprise: setting up the connection over the direct path between the first terminal device and the target network node, after accessing to the target network node.

In accordance with an exemplary embodiment, the configuration information may include an identifier of the target network node.

In accordance with an exemplary embodiment, the method according to the first aspect of the present disclosure may further comprise: receiving, from the first network node via the second terminal device, a parameter to indicate a validity period of the configuration information.

In accordance with an exemplary embodiment, the method according to the first aspect of the present disclosure may further comprise: transmitting a message to the second terminal device to release an indirect path between the first terminal device and the first network node via the second terminal device, in response to starting or finishing connection setup over the direct path between the first terminal device and the target network node.

In accordance with an exemplary embodiment, the first terminal device may have a service requiring latency lower than a threshold.

In accordance with an exemplary embodiment, the first terminal device may be not in RRC connected mode before the connection over the direct path is set up for the first terminal device.

In accordance with an exemplary embodiment, the second terminal device may support a layer-2 (L2) relaying capability and/or a layer-3 (L3) relaying capability.

According to a second aspect of the present disclosure, there is provided an apparatus which may be implemented as a first terminal device. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a first terminal device. The apparatus may comprise a determining unit and a transmitting unit. In accordance with some exemplary embodiments, the determining unit may be operable to carry out at least the determining step of the method according to the first aspect of the present disclosure. The transmitting unit may be operable to carry out at least the transmitting step of the method according to the first aspect of the present disclosure.

According to a fifth aspect of the present disclosure, there is provided a method performed by a second terminal device such as a UE. The method comprises: receiving first information from a first terminal device. The first information may be about whether to set up a connection over a direct path between the first terminal device and a target network node in a communication network. In accordance with an exemplary embodiment, the method further comprises: transmitting the first information to a first network node. The target network node may be the first network node or a second network node different from the first network node in the communication network.

In accordance with some exemplary embodiments, the first terminal device, the second terminal device and the first network node described according to the fifth aspect of the present disclosure may correspond to the first terminal device, the second terminal device and the first network node described according to the first aspect of the present disclosure, respectively.

In accordance with an exemplary embodiment, the method according to the fifth aspect of the present disclosure may further comprise: receiving, from the first network node, second information about whether the connection over the direct path is to be set up for the first terminal device; and transmitting the second information to the first terminal device.

In accordance with an exemplary embodiment, the first information and the second information described according to the fifth aspect of the present disclosure may correspond to the first information and the second information described according to the first aspect of the present disclosure, respectively.

In accordance with an exemplary embodiment, the first information may be received from the first terminal device by the second terminal device, when the first terminal device has traffic towards the communication network.

In accordance with an exemplary embodiment, the method according to the fifth aspect of the present disclosure may further comprise: receiving, from the first terminal device, a notification that the first terminal device has traffic towards the communication network; and transmitting the notification to the first network node.

In accordance with an exemplary embodiment, the method according to the fifth aspect of the present disclosure may further comprise: receiving, from the first network node, configuration information for setting up the connection over the direct path for the first terminal device; and transmitting the configuration information to the first terminal device.

In accordance with an exemplary embodiment, the method according to the fifth aspect of the present disclosure may further comprise: receiving, from the first network node, a parameter to indicate a validity period of the configuration information; and transmitting the received parameter to the first terminal device.

In accordance with an exemplary embodiment, the method according to the fifth aspect of the present disclosure may further comprise: receiving a message from the first terminal device to release an indirect path between the first terminal device and the first network node via the second terminal device, when connection setup over the direct path between the first terminal device and the target network node is started or finished.

In accordance with an exemplary embodiment, the method according to the fifth aspect of the present disclosure may further comprise: receiving a first control message from the first network node, and transmitting the first control message to the first terminal device. The first control message may include an identifier of the first terminal device.

In accordance with an exemplary embodiment, the method according to the fifth aspect of the present disclosure may further comprise: receiving a second control message from the first terminal device; including an identifier of the first terminal device into the second control message; and transmitting the second control message including the identifier of the first terminal device to the first network node.

According to a sixth aspect of the present disclosure, there is provided an apparatus which may be implemented as a second terminal device. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a second terminal device. The apparatus may comprise a receiving unit and a transmitting unit. In accordance with some exemplary embodiments, the receiving unit may be operable to carry out at least the receiving step of the method according to the fifth aspect of the present disclosure. The transmitting unit may be operable to carry out at least the transmitting step of the method according to the fifth aspect of the present disclosure.

According to a ninth aspect of the present disclosure, there is provided a method performed by a first network node such as a base station. The method comprises: receiving first information from a first terminal device via a second terminal device. The first information may be about whether to set up a connection over a direct path between the first terminal device and a target network node in a communication network. In accordance with an exemplary embodiment, the method further comprises: determining whether the connection over the direct path is to be set up for the first terminal device, according to the first information. The target network node may be the first network node or a second network node different from the first network node in the communication network.

In accordance with some exemplary embodiments, the first terminal device, the second terminal device and the first network node described according to the ninth aspect of the present disclosure may correspond to the first terminal device, the second terminal device and the first network node described according to the first aspect of the present disclosure, respectively.

In accordance with an exemplary embodiment, the method according to the ninth aspect of the present disclosure may further comprise: transmitting, to the first terminal device via the second terminal device, second information about whether the connection over the direct path is to be set up for the first terminal device.

In accordance with an exemplary embodiment, the first information and the second information described according to the ninth aspect of the present disclosure may correspond to the first information and the second information described according to the first aspect of the present disclosure, respectively.

In accordance with an exemplary embodiment, the first network node may receive the first information from the first terminal device via the second terminal device, when the first terminal device has traffic towards the communication network.

In accordance with an exemplary embodiment, the method according to the ninth aspect of the present disclosure may further comprise: receiving, from the first terminal device via the second terminal device, a notification that the first terminal device has traffic towards the communication network.

In accordance with an exemplary embodiment, the method according to the ninth aspect of the present disclosure may further comprise: transmitting, to the first terminal device via the second terminal device, configuration information for setting up the connection over the direct path for the first terminal device.

In accordance with an exemplary embodiment, the method according to the ninth aspect of the present disclosure may further comprise: transmitting, to the first terminal device via the second terminal device, a parameter to indicate a validity period of the configuration information.

In accordance with an exemplary embodiment, the method according to the ninth aspect of the present disclosure may further comprise: transmitting a first control message for the first terminal device to the second terminal device. The first control message may include an identifier of the first terminal device.

In accordance with an exemplary embodiment, the method according to the ninth aspect of the present disclosure may further comprise: receiving a second control message for the first terminal device from the second terminal device. The second control message may include an identifier of the first terminal device.

According to a tenth aspect of the present disclosure, there is provided an apparatus which may be implemented as a first network node. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a first network node. The apparatus may comprise a receiving unit and a determining unit. In accordance with some exemplary embodiments, the receiving unit may be operable to carry out at least the receiving step of the method according to the ninth aspect of the present disclosure. The determining unit may be operable to carry out at least the determining step of the method according to the ninth aspect of the present disclosure.

According to a thirteenth aspect of the present disclosure, there is provided a method performed by a first terminal device such as a UE. The method comprises: receiving, from a second terminal device, third information about whether a connection is to be set up over a direct path between the first terminal device and a target network node in a communication network. In accordance with an exemplary embodiment, the method further comprises: determining whether to set up the connection over the direct path for the first terminal device, according to the third information. The target network node may be the first network node or a second network node different from the first network node in the communication network.

In accordance with an exemplary embodiment, the third information may comprise a decision made by the second terminal device about whether the connection over the direct path is set up for the first terminal device.

In accordance with an exemplary embodiment, the third information may comprise a decision made by the first network node about whether the connection over the direct path is to be set up for the first terminal device.

In accordance with an exemplary embodiment, the third information may indicate to set up the connection over the direct path between the first terminal device and the target network node.

In accordance with an exemplary embodiment, the third information may be received from the second terminal device by the first terminal device, when the first terminal device has traffic towards the communication network.

In accordance with an exemplary embodiment, the method according to the thirteenth aspect of the present disclosure may further comprise: transmitting, to the first network node via the second terminal device, a notification that the first terminal device has traffic towards the communication network.

In accordance with an exemplary embodiment, the second terminal device may be operated in RRC connected mode, e.g., as described according to the first aspect of the present disclosure.

In accordance with an exemplary embodiment, the method according to the thirteenth aspect of the present disclosure may further comprise: receiving, from the first network node via the second terminal device, configuration information for setting up the connection over the direct path for the first terminal device.

In accordance with an exemplary embodiment, the configuration information may include an RNTI (e.g. a C-RNTI, etc.) for the first terminal device over the direct path, and/or indicate a contention free random access preamble and/or resource for the first terminal device over the direct path. In an embodiment, the configuration information may include an identifier of the target network node.

In accordance with an exemplary embodiment, the first terminal device may set up the connection over the direct path between the first terminal device and the target network node according to the configuration information, e.g., as described according to the first aspect of the present disclosure.

In accordance with an exemplary embodiment, the method according to the thirteenth aspect of the present disclosure may further comprise: receiving, from the first network node via the second terminal device, a parameter to indicate a validity period of the configuration information.

In accordance with an exemplary embodiment, the method according to the thirteenth aspect of the present disclosure may further comprise: transmitting a message to the second terminal device to release an indirect path between the first terminal device and the first network node via the second terminal device, in response to starting or finishing connection setup over the direct path between the first terminal device and the target network node.

In accordance with an exemplary embodiment, the first terminal device may have a service requiring latency lower than a threshold.

In accordance with an exemplary embodiment, the first terminal device may be not in RRC connected mode before the connection over the direct path is set up for the first terminal device.

In accordance with an exemplary embodiment, the second terminal device may support a L2 relaying capability and/or a L3 relaying capability.

In accordance with some exemplary embodiments, the first terminal device described according to the thirteenth aspect of the present disclosure may be configured to perform any step of the method according to the first aspect of the present disclosure.

According to a fourteenth aspect of the present disclosure, there is provided an apparatus which may be implemented as a first terminal device. The apparatus may comprise one or more processors and one or more memories storing computer program codes. The one or more memories and the computer program codes may be configured to, with the one or more processors, cause the apparatus at least to perform any step of the method according to the thirteenth aspect of the present disclosure.

According to a fifteenth aspect of the present disclosure, there is provided a computer-readable medium having computer program codes embodied thereon which, when executed on a computer, cause the computer to perform any step of the method according to the thirteenth aspect of the present disclosure.

According to a sixteenth aspect of the present disclosure, there is provided an apparatus which may be implemented as a first terminal device. The apparatus may comprise a receiving unit and a determining unit. In accordance with some exemplary embodiments, the receiving unit may be operable to carry out at least the receiving step of the method according to the thirteenth aspect of the present disclosure. The determining unit may be operable to carry out at least the determining step of the method according to the thirteenth aspect of the present disclosure.

According to a seventeenth aspect of the present disclosure, there is provided a method performed by a second terminal device such as a UE. The method comprises: determining fourth information about whether a connection is to be set up over a direct path between a first terminal device and a target network node in a communication network. In accordance with an exemplary embodiment, the method further comprises: transmitting the fourth information to the first terminal device and/or a first network node. The target network node may be the first network node or a second network node different from the first network node in the communication network.

In accordance with some exemplary embodiments, the first terminal device, the second terminal device and the first network node described according to the seventeenth aspect of the present disclosure may correspond to the first terminal device, the second terminal device and the first network node described according to the thirteenth aspect of the present disclosure, respectively.

In accordance with an exemplary embodiment, the fourth information may comprise a decision made by the second terminal device about whether the connection over the direct path is to be set up for the first terminal device.

In accordance with an exemplary embodiment, the fourth information may indicate to set up the connection over the direct path between the first terminal device and the target network node.

In accordance with an exemplary embodiment, the fourth information may comprise: third measurement information of a path between the second terminal device and the first network node, and/or fourth measurement information of a path between the first terminal device and the second terminal device.

In accordance with an exemplary embodiment, the fourth information may be transmitted to the first terminal device and/or the first network node by the second terminal device, when the first terminal device has traffic towards the communication network.

In accordance with an exemplary embodiment, the method according to the seventeenth aspect of the present disclosure may further comprise: receiving, from the first terminal device, a notification that the first terminal device has traffic towards the communication network; and transmitting the notification to the first network node.

In accordance with an exemplary embodiment, the method according to the seventeenth aspect of the present disclosure may further comprise: receiving, from the first network node, fifth information about whether the connection over the direct path is to be set up for the first terminal device; and transmitting the fifth information to the first terminal device.

In accordance with an exemplary embodiment, the fifth information may comprise a decision made by the first network node about whether the connection over the direct path is to be set up for the first terminal device.

In accordance with an exemplary embodiment, the fifth information may indicate to set up the connection over the direct path between the first terminal device and the target network node.

In accordance with an exemplary embodiment, the second terminal device may be operated in RRC connected mode, e.g., as described according to the first aspect of the present disclosure.

In accordance with an exemplary embodiment, the method according to the seventeenth aspect of the present disclosure may further comprise: receiving, from the first network node, configuration information for setting up the connection over the direct path for the first terminal device; and transmitting the configuration information to the first terminal device.

In accordance with an exemplary embodiment, the method according to the seventeenth aspect of the present disclosure may further comprise: receiving, from the first network node, a parameter to indicate a validity period of the configuration information; and transmitting the received parameter to the first terminal device.

In accordance with an exemplary embodiment, the method according to the seventeenth aspect of the present disclosure may further comprise: receiving a message from the first terminal device to release an indirect path between the first terminal device and the first network node via the second terminal device, when connection setup over the direct path between the first terminal device and the target network node is started or finished.

In accordance with an exemplary embodiment, the method according to the seventeenth aspect of the present disclosure may further comprise: receiving a third control message from the first network node, and transmitting the third control message to the first terminal device. The third control message may include an identifier of the first terminal device.

In accordance with an exemplary embodiment, the method according to the seventeenth aspect of the present disclosure may further comprise: receiving a fourth control message from the first terminal device; including an identifier of the first terminal device into the fourth control message; and transmitting the fourth control message including the identifier of the first terminal device to the first network node.

According to an eighteenth aspect of the present disclosure, there is provided an apparatus which may be implemented as a second terminal device. The apparatus may comprise one or more processors and one or more memories storing computer program codes. The one or more memories and the computer program codes may be configured to, with the one or more processors, cause the apparatus at least to perform any step of the method according to the seventeenth aspect of the present disclosure.

According to a nineteenth aspect of the present disclosure, there is provided a computer-readable medium having computer program codes embodied thereon which, when executed on a computer, cause the computer to perform any step of the method according to the seventeenth aspect of the present disclosure.

According to a twentieth aspect of the present disclosure, there is provided an apparatus which may be implemented as a second terminal device. The apparatus may comprise a determining unit and a transmitting unit. In accordance with some exemplary embodiments, the determining unit may be operable to carry out at least the determining step of the method according to the seventeenth aspect of the present disclosure. The transmitting unit may be operable to carry out at least the transmitting step of the method according to the seventeenth aspect of the present disclosure.

According to a twenty-first aspect of the present disclosure, there is provided a method performed by a first network node such as a base station. The method comprises: receiving fourth information from a second terminal device. The fourth information may be about whether a connection is to be set up over a direct path between a first terminal device and a target network node in a communication network. In accordance with an exemplary embodiment, the method further comprises: determining whether the connection over the direct path is to be set up for the first terminal device, according to the fourth information. The target network node may be the first network node or a second network node different from the first network node in the communication network.

In accordance with an exemplary embodiment, the first network node may receive the fourth information from the second terminal device, when the first terminal device has traffic towards the communication network.

In accordance with an exemplary embodiment, the method according to the twenty-first aspect of the present disclosure may further comprise: receiving, from the first terminal device via the second terminal device, a notification that the first terminal device has traffic towards the communication network.

In accordance with an exemplary embodiment, the method according to the twenty-first aspect of the present disclosure may further comprise: transmitting, to the first terminal device via the second terminal device, fifth information about whether the connection over the direct path is to be set up for the first terminal device.

In accordance with an exemplary embodiment, the fourth information and the fifth information described according to the twenty-first aspect of the present disclosure may correspond to the fourth information and the fifth information described according to the seventeenth aspect of the present disclosure, respectively.

In accordance with an exemplary embodiment, the method according to the twenty-first aspect of the present disclosure may further comprise: transmitting, to the first terminal device via the second terminal device, configuration information for setting up the connection over the direct path for the first terminal device.

In accordance with an exemplary embodiment, the method according to the twenty-first aspect of the present disclosure may further comprise: transmitting, to the first terminal device via the second terminal device, a parameter to indicate a validity period of the configuration information.

In accordance with an exemplary embodiment, the method according to the twenty-first aspect of the present disclosure may further comprise: transmitting a third control message for the first terminal device to the second terminal device. The third control message may include an identifier of the first terminal device.

In accordance with an exemplary embodiment, the method according to the twenty-first aspect of the present disclosure may further comprise: receiving a fourth control message for the first terminal device from the second terminal device. The fourth control message may include an identifier of the first terminal device.

According to a twenty-second aspect of the present disclosure, there is provided an apparatus which may be implemented as a first network node. The apparatus may comprise one or more processors and one or more memories storing computer program codes. The one or more memories and the computer program codes may be configured to, with the one or more processors, cause the apparatus at least to perform any step of the method according to the twenty-first aspect of the present disclosure.

According to a twenty-third aspect of the present disclosure, there is provided a computer-readable medium having computer program codes embodied thereon which, when executed on a computer, cause the computer to perform any step of the method according to the twenty-first aspect of the present disclosure.

According to a twenty-fourth aspect of the present disclosure, there is provided an apparatus which may be implemented as a first network node. The apparatus may comprise a receiving unit and a determining unit. In accordance with some exemplary embodiments, the receiving unit may be operable to carry out at least the receiving step of the method according to the twenty-first aspect of the present disclosure. The determining unit may be operable to carry out at least the determining step of the method according to the twenty-first aspect of the present disclosure.

According to a twenty-fifth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the ninth or twenty-first aspect of the present disclosure.

According to a twenty-sixth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the ninth or twenty-first aspect of the present disclosure.

According to a twenty-seventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first, fifth, thirteenth or seventeenth aspect of the present disclosure.

According to a twenty-eighth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first, fifth, thirteenth or seventeenth aspect of the present disclosure.

According to a twenty-ninth aspect of the present disclosure, there is provided a method implemented in a communication system which may include a host computer, a base station and a UE. The method may comprise, at the host computer, receiving user data transmitted to the base station from the UE which may perform any step of the method according to the first, fifth, thirteenth or seventeenth aspect of the present disclosure.

According to a thirtieth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first, fifth, thirteenth or seventeenth aspect of the present disclosure.

According to a thirty-first aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the ninth or twenty-first aspect of the present disclosure.

According to a thirty-second aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the ninth or twenty-first aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIGS. 1A-1B are diagrams illustrating exemplary protocol stacks for a Layer-2 (L2) UE-to-NW relay UE according to some embodiments of the present disclosure;

FIG. 2 is a diagram illustrating an exemplary protocol stack for a Layer-3 (L3) UE-to-NW relay UE according to an embodiment of the present disclosure;

FIGS. 3A-3C are flowcharts illustrating various methods according to some embodiments of the present disclosure;

FIGS. 4A-4C are flowcharts illustrating various methods according to some embodiments of the present disclosure;

FIG. 5 is a block diagram illustrating an apparatus according to some embodiments of the present disclosure;

FIGS. 6A-6F are block diagrams illustrating various apparatuses according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

3GPP specifies the LTE D2D technology, also known as ProSe (Proximity Services) in Release 12 and Release 13 of LTE. Later in Release 14 and Release 15, LTE V2X related enhancements targeting the specific characteristics of vehicular communications are specified. 3GPP has started a new work item (WI) within the scope of Release 16 to develop a NR version of V2X communications. The NR V2X mainly targets advanced V2X services, which may be categorized into four use case groups: vehicles platooning, extended sensors, advanced driving and remote driving. The advanced V2X services may require the enhanced NR system and new NR sidelink framework to meet the stringent requirements in terms of latency and reliability. The NR V2X system may also expect to have higher system capacity and better coverage and to allow for an easy extension to support the future development of further advanced V2X services and other services.

Given the targeted services by NR V2X, it is commonly recognized that groupcast/multicast and unicast transmissions may be desired, in which the intended receiver of a message may consist of only a subset of the vehicles in proximity to the transmitter (groupcast) or of a single vehicle (unicast). For example, in the platooning service, there are certain messages that are only of interest of the members of the platoon, making the members of the platoon a natural groupcast. In another example, the see-through use case most likely involves only a pair of vehicles, for which unicast transmissions may naturally fit. Therefore, NR sidelink can support broadcast (as in LTE), groupcast and unicast transmissions. Furthermore, NR sidelink may be designed in such a way that its operation is possible with and without network coverage and with varying degrees of interaction between the UEs and the NW, including support for standalone, network-less operation.

In 3GPP Release 17, discussions are being taken place and national security and public safety (NSPS) is considered to be one of important use cases, which can benefit from the already developed NR sidelink features in Release 16. Therefore, it is most likely that 3GPP may specify enhancements related to NSPS use case taking NR Release 16 sidelink as a baseline. Besides, in some scenarios, NSPS services may need to operate with partial or without NW coverage, such as indoor firefighting, forest firefighting, earthquake rescue, sea rescue, etc., where the infrastructure may be (partially) destroyed or not available. Therefore, coverage extension may be a crucial enabler for NSPS, for both NSPS services communicated between a UE and a cellular NW and communicated between UEs over sidelink. In Release 17, a new study item description (SID) on NR sidelink relay is launched, which aims to further explore coverage extension for sidelink-based communication, including both UE-to-NW relay for cellular coverage extension and UE-to-UE relay for sidelink coverage extension.

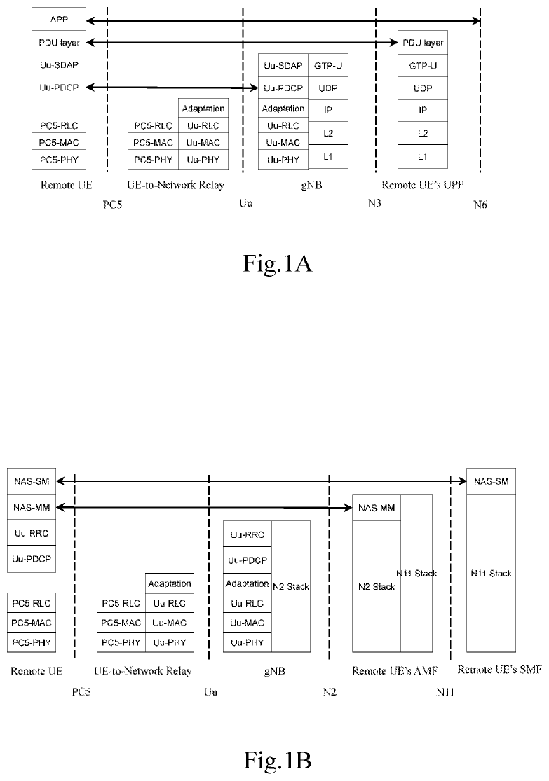

FIGS. 1A-1B are diagrams illustrating exemplary protocol stacks for a L2 UE-to-NW relay UE according to some embodiments of the present disclosure. The L2 UE-to-NW relay UE (i.e. the UE-to-Network relay in FIG. 1A and FIG. 1B) may provide the functionality to support connectivity to the 5G system (5GS) for remote UEs. The protocol stacks for L2 UE-to-NW relay UE are shown in FIG. 1A and FIG. 1B for user plane and control plane respectively.

For simplicity, FIG. 1A only depicts exemplary devices/elements, e.g., a remote UE, a UE-to-Network relay, a gNB and a remote UE's user plane function (UPF). As an example, the remote UE may have protocol layers including a physical layer on PC5 interface (PC5-PHY), a medium access control layer on PC5 interface (PC5-MAC), a radio link control layer on PC5 interface (PC5-RLC), a packet data convergence protocol layer on Uu interface (Uu-PDCP), a service data adaptation protocol layer on Uu interface (Uu-SDAP), a protocol data unit (PDU) layer, and an application layer (APP). FIG. 1A also shows other network devices/elements with corresponding protocol layers.

Similarly, FIG. 1B only depicts exemplary devices/elements, e.g., a remote UE, a UE-to-Network relay, a gNB, a remote UE's access and mobility management function (AMF), and a remote UE's session management function (SMF). As an example, the remote UE may have protocol layers including PC5-PHY, PC5-MAC, PC5-RLC, Uu-PDCP, an RRC layer on Uu interface (Uu-RRC), a non-access stratum mobility management layer (NAS-MM), and a non-access stratum session management layer (NAS-SM). FIG. 1B also shows other network devices/elements with corresponding protocol layers.

It is important to note that the two endpoints of the PDCP link in FIG. 1A are the remote UE and the gNB, which means the remote UE may have its own context in a radio access network (RAN) and the core NW. Thus, the remote UE may have its own radio bearer, RRC connection and PDU session. The relay function may be performed below the PDCP layer, e.g. the adaptation layer. The remote UE's traffic (both control plane and user plane) may be transparently transferred between the remote UE and the gNB over the L2 UE-to-NW relay UE without any modifications.

In accordance with an exemplary embodiment, the adaptation layer between the L2 UE-to-NW relay UE and the gNB may be able to differentiate between Uu bearers of a particular remote UE. Different remote UEs and different Uu bearers of the remote UE may be indicated by additional information (e.g. UE identifiers (IDs) and bearer IDs) included in an adaptation layer header which may be added to the PDCP PDU. The adaptation layer may be considered as part of PDCP sublayer or a separate new layer between PDCP sublayer and RLC sublayer.

When both the remote UE and the L2 UE-to-NW relay UE are in RRC idle/inactive mode and there is incoming DL traffic for the remote UE, the NW may first page the remote UE, and the L2 UE-to-NW relay UE may monitor the paging and inform the remote UE that there is DL traffic for the remote UE. Then both the remote UE and the L2 UE-to-NW relay UE may establish/resume the RRC connection to the gNB, and the remote UE's traffic may be transparently transferred between the remote UE and the gNB via the L2 UE-to-NW relay UE.

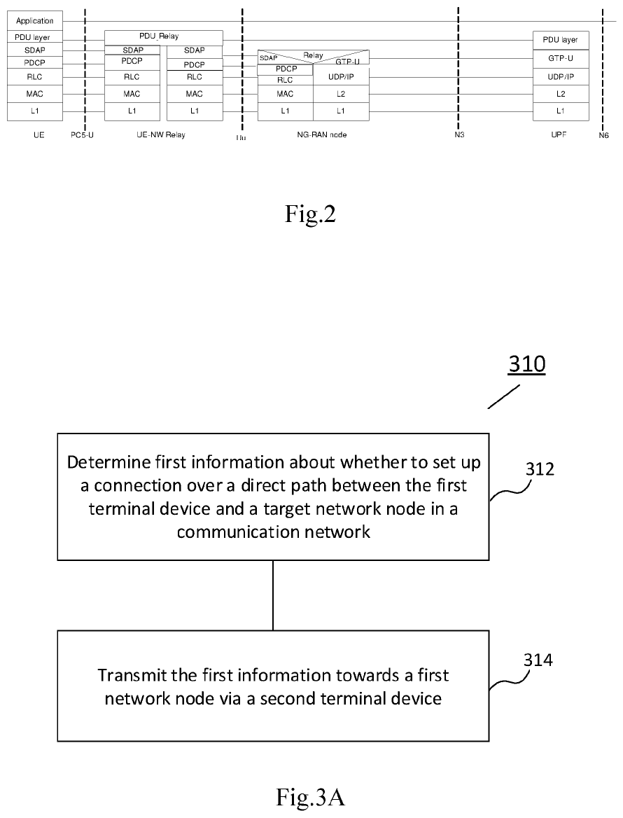

FIG. 2 is a diagram illustrating an exemplary protocol stack for a L3 UE-to-NW relay UE according to an embodiment of the present disclosure. The L3 UE-to-NW relay UE (i.e. the UE-NW relay in FIG. 2) may relay unicast traffic (UL and DL) between a remote UE and a new generation-radio access network (NG-RAN) node, for example, by providing a generic function that can relay any Internet protocol (IP), Ethernet or Unstructured traffic. According to the protocol stack for the L3 UE-to-NW relay UE as shown in FIG. 2, relaying may be performed in the PDU layer. The remote UE is invisible to the core NW, i.e. the remote UE does not have its own context and PDU session in the core NW. The traffic of the remote UE may be forwarded in the L3 UE-to-NW relay UE's PDU session. For IP PDU session type and IP traffic over PC5 reference point, the L3 UE-to-NW relay UE may allocate Internet protocol version 6 (IPv6) prefix or Internet protocol version 4 (IPv4) address for the remote UE.

In the case that the L3 UE-to-NW relay UE is in RRC idle/inactive mode and there is incoming DL traffic for the remote UE, the NW may first page the L3 UE-to-NW relay UE, which may trigger the L3 UE-to-NW relay UE to establish/resume the RRC connection. Then the NW may send the remote UE's traffic to the L3 UE-to-NW relay UE which may further forward it to the remote UE.

According to the existing solutions, when a UE in RRC idle/inactive mode wants to establish/resume an RRC connection, it may first start a random access procedure to acquire layer-1/layer-2 (L1/L2) access to the NW, and only contention based random access can be adopted for the UE in RRC idle/inactive mode, which has higher latency than contention free random access. After acquiring the L1/L2 access, the UE sends an RRC connection establishment/resumption request to the NW to establish/resume the RRC connection, after which the UE context is built in a gNB and (unicast) transmission may be performed between the gNB and the UE.

Various exemplary embodiments of the present disclosure propose a solution to enable fast RRC connection establishment/resumption over a direct path for a remote UE, e.g., with the help of a UE-to-NW relay UE. The proposed solution may be applied for both use cases of L2 UE-to-NW relay UE and L3 UE-to-NW relay UE. According to the proposed solution, the latency in RRC connection establishment/resumption over the direct path for the remote UE may be reduced to a large extent, which may also improve the end user experience.

In accordance with some exemplary embodiments, the remote UE or the UE-to-NW relay UE may determine whether the remote UE can establish/resume an RRC connection over the direct path and inform such decision to the NW (e.g., a gNB, etc.).

In accordance with some exemplary embodiments, the gNB may determine whether the remote UE can establish/resume an RRC connection over the direct path, e.g. based on assistance information from the remote UE or the UE-to-NW relay UE, and inform such decision to the remote UE, e.g. via the UE-to-NW relay UE.

In accordance with some exemplary embodiments, the gNB may configure a cell-radio network temporary identifier (C-RNTI) for the remote UE to be used over the direct path, and inform the C-RNTI to the remote UE via the UE-to-NW relay UE. The remote UE may monitor the physical downlink control channel (PDCCH) scrambled by the C-RNTI to obtain a UL grant for sending an RRC connection establishment/resumption request.

In accordance with some exemplary embodiments, the gNB may configure a contention free random access preamble/resource for the remote UE to be used over the direct path, and inform the contention free random access preamble/resource to the remote UE via the UE-to-NW relay UE. The remote UE may perform contention free random access to acquire L1/L2 access to the NW and then perform RRC connection establishment/resumption.

It can be appreciated that although some exemplary embodiments are described in the context of NR sidelink communications, various embodiments described in the present disclosure may be in general applicable to any kind of direct communications between UEs involving D2D communications.

In accordance with an exemplary embodiment, a remote UE may measure the link quality on Uu interface towards a candidate gNB and/or on PC5 interface towards the linked UE-to-NW relay UE. It can be appreciated that the candidate gNB may be or may not be the serving gNB which is currently connected with the UE-to-NW relay UE. In an embodiment, the remote UE not in RRC connected mode may determine by itself whether an RRC connection may be established/resumed over the direct path between the remote UE and the NW, and inform such decision to the linked UE-to-NW relay UE using PC5-RRC signaling. Then the UE-to-NW relay UE may further forward the decision to the serving gNB. In another embodiment, the remote UE may only send the decision to the UE-to-NW relay UE when the remote UE determines that the RRC connection may be established/resumed over the direct path.

In accordance with an exemplary embodiment, the remote UE not in RRC connected mode may send the measurement results to the linked UE-to-NW relay UE using PC5-RRC signaling. The UE-to-NW relay UE may further forward the measurement results to the serving gNB. Then the serving gNB may determine whether the remote UE can establish/resume an RRC connection over the direct path, and inform the decision to the UE-to-NW relay UE using Uu RRC signaling. The UE-to-NW relay UE may further inform the decision to the remote UE using PC5-RRC signaling. In another embodiment, the serving gNB may only send the decision to the UE-to-NW relay UE when the serving gNB determines that the remote UE's RRC connection may be established/resumed over the direct path.

In accordance with an exemplary embodiment, the serving gNB may configure the remote UE to perform measurements while not in RRC connected mode. In an embodiment, the serving gNB may generate measurement configuration information and send it to the remote UE via the UE-to-NW relay UE. In another embodiment, the serving gNB may instruct the UE-to-NW relay UE to send measurement configuration information to the remote UE for performing measurements while not in RRC connected mode, if the UE-to-NW relay UE already has the measurement configuration information in its memory. Yet, in another embodiment, the measurement configuration information for performing measurements by the remote UE while not in RRC connected mode may be generated and sent to the remote UE by the UE-to-NW relay UE.

In accordance with an exemplary embodiment, a UE-to-NW relay UE may measure the link quality on Uu interface towards the serving gNB and/or PC5 interface towards the linked remote UE. In an embodiment, the UE-to-NW relay UE may determine by itself whether the remote UE not in RRC connected mode may establish/resume an RRC connection over the direct path between the remote UE and the NW, and inform such decision to the remote UE using PC5-RRC signaling, and/or to the serving gNB using Uu RRC signaling. In another embodiment, the UE-to-NW relay UE may only send the decision to the remote UE and/or the serving gNB when the UE-to-NW relay UE determines that the remote UE's RRC connection may be established/resumed over the direct path.

In accordance with an exemplary embodiment, the UE-to-NW relay UE may send the measurement results to the serving gNB using Uu RRC signaling. Then the serving gNB may determine whether the linked remote UE can establish/resume an RRC connection over the direct path, and inform the decision to the UE-to-NW relay UE using Uu RRC signaling. The UE-to-NW relay UE may further inform the decision to the remote UE using PC5-RRC signaling. In another embodiment, the serving gNB may only send the decision to the UE-to-NW relay UE when it determines that the remote UE's RRC connection may be established/resumed over the direct path.

In accordance with an exemplary embodiment, the remote UE or the UE-to-NW relay UE may send the decision or the measurement report (including the measurement results) towards the serving gNB, e.g., only when the remote UE has data/traffic (to be) sent to the NW. By receiving the decision or the measurement report, the serving gNB may implicitly know that the remote UE has data/traffic (to be) sent to the NW. Alternatively or additionally, the remote UE may explicitly inform the UE-to-NW relay UE that the remote UE has data/traffic to be sent to the NW, and the UE-to-NW relay UE may further inform this to the serving gNB.

In accordance with an exemplary embodiment, when communicating a message (e.g., a control message or any other suitable messages) with the serving gNB, the UE-to-NW relay UE may need to be in RRC connected mode. In an embodiment, the remote UE may inform the UE-to-NW relay UE in advance that there may be a (control) message to be relayed, which may trigger the UE-to-NW relay UE to establish/resume its RRC connection in advance if it is currently in RRC idle/inactive mode. In another embodiment, based on the service type and/or quality of service (QoS) requirement of the remote UE's service(s) that may go through the core NW, the NW may keep the UE-to-NW relay UE in RRC connected mode. Alternatively or additionally, the above procedure (e.g., informing the NW of the decision, and/or the measurement report, and/or that the remote UE has data/traffic to be sent to the NW) may only be performed when the linked UE-to-NW relay UE is in RRC connected mode. It can be appreciated that the UE-to-NW relay UE may need to be in RRC connected mode if any of the linked remote UEs has data/traffic being sent to the NW, which may imply that the UE-to-NW relay UE may be in RRC connected mode even if some of the linked remote UE(s) currently may have no data/traffic sent to the NW.

In accordance with an exemplary embodiment, when it is determined that the remote UE can establish/resume its RRC connection over the direct path, and the serving gNB knows, either explicitly or implicitly, that the remote UE has data/traffic to be sent to the NW, the serving gNB may configure a C-RNTI for the remote UE to be used over the direct path and inform the C-RNTI to the UE-to-NW relay UE using Uu RRC signaling. The UE-to-NW relay UE may further forward the C-RNTI to the remote UE using PC5-RRC signaling. In the case that the direct path is towards a gNB different from the current gNB (i.e., the gNB selected from one or more candidate gNBs for the direct path is different from the serving gNB of the UE-to-NW relay UE), the current gNB may communicate with the gNB of the direct path to obtain the C-RNTI to be used, and inform both the C-RNTI and the ID of the gNB of the direct path to the remote UE via the UE-to-NW relay UE. The remote UE may monitor the PDCCH scrambled by the C-RNTI sent from the gNB of the direct path to obtain e.g. a UL grant. Then the remote UE may start an RRC connection establishment/resumption procedure by sending an RRC connection establishment/resumption request to the gNB in UL over the direct path. In this way, the RRC connection establishment/resumption procedure may be performed without performing a (contention based) random access procedure.

In accordance with an exemplary embodiment, when it is determined that the remote UE can establish/resume its RRC connection over the direct path, and the serving gNB knows, either explicitly or implicitly, that the remote UE has data/traffic to be sent to the NW, the serving gNB may configure a contention free random access preamble/resource for the remote UE to be used for random access over the direct path, and inform the contention free random access preamble/resource to the UE-to-NW relay UE using Uu RRC signaling. The UE-to-NW relay UE may further forward the contention free random access preamble/resource to the remote UE using PC5-RRC signaling. In the case that the gNB determined for the direct path is different from the serving gNB of the UE-to-NW relay UE, the serving gNB may communicate with the gNB of the direct path to obtain the contention free random access preamble/resource to be used, and inform both the contention free random access preamble/resource and the ID of the gNB of the direct path to the remote UE via the UE-to-NW relay UE. According to the contention free random access preamble/resource, the remote UE may perform contention free random access towards the gNB of the direct path to acquire the L1/L2 access, and then start an RRC connection establishment/resumption procedure by sending an RRC connection establishment/resumption request to the gNB in UL over the direct path. In this way, the RRC connection establishment/resumption procedure may be performed with contention free random access.

In accordance with an exemplary embodiment, the gNB that configures one or more parameters to the remote UE may also indicate how long the one or more parameters (e.g., the C-RNTI and/or the contention free random access preamble/resource, etc.) are valid. The remote UE may only apply the one or more parameters during their valid time period. In an embodiment, when the UE-to-NW relay UE sends/relays control information for one linked remote UE, the UE-to-NW relay UE may indicate to which remote UE the control information is relevant. For instance, the UE-to-NW relay UE may include an L2 ID of the remote UE or a local ID determined by the UE-to-NW relay UE in the RRC message for control information sent to the gNB, by which the gNB can understand that the control information is for a certain remote UE linked to the UE-to-NW relay UE. Alternatively or additionally, the gNB may also include such ID in the RRC message sent to the UE-to-NW relay UE for control information for the specific linked remote UE.

In accordance with an exemplary embodiment, once the remote UE starts (or finishes) RRC connection establishment/resumption over the direct path, the remote UE may send a message (e.g., a PC5-RRC message, etc.) to the UE-to-NW relay UE to release the indirect/relay path of the remote UE (e.g., a path between the remote UE and the UE-to-NW relay UE and potentially a path between the UE-to-NW relay UE and the gNB) and/or PC5 bearer(s) used for relaying the Uu traffic of the remote UE.

It can be appreciated that various exemplary embodiments may be applied for both cases of L2 UE-to-NW relaying (e.g. as described with respect to FIG. 1A and FIG. 1B) and L3 UE-to-NW relaying (e.g. as described with respect to FIG. 2). When linked to an L3 UE-to-NW relay UE, the remote UE may be not in RRC connected mode no matter if it has data/traffic being sent to the NW. In addition, it also can be appreciated that the proposed solution for establishing/resuming an RRC connection for a remote UE over a direct path may be performed adaptively, for example, according to predetermined configuration, and/or only when the remote UE has a service requiring low latency to be sent to the NW.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

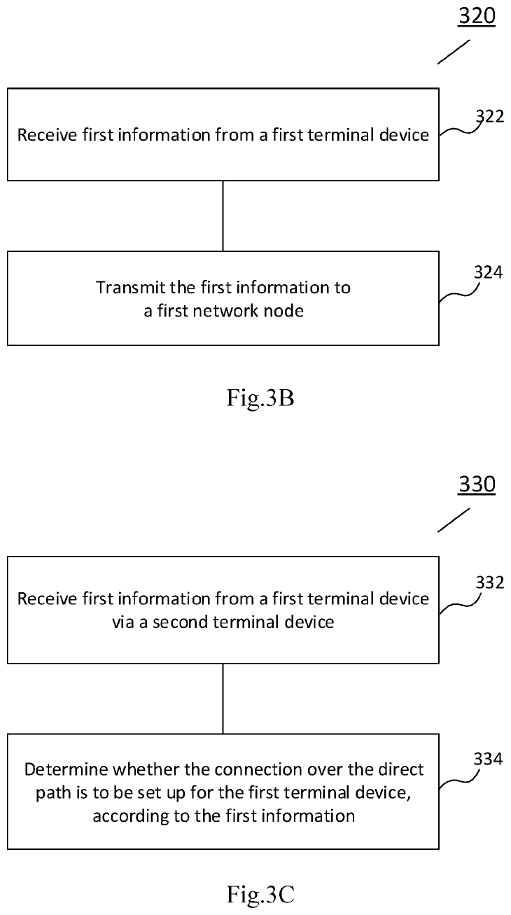

FIG. 3A is a flowchart illustrating a method 310 according to some embodiments of the present disclosure. The method 310 illustrated in FIG. 3A may be performed by a first terminal device (e.g., the remote UE shown in FIGS. 1A-1B and the UE shown in FIG. 2) or an apparatus communicatively coupled to the first terminal device. In accordance with an exemplary embodiment, the first terminal device may be configured to support D2D communication (e.g., V2X or SL communication, etc.) with other devices. In an exemplary embodiment, the first terminal device may be configured to communicate with a network node (e.g., the gNB shown in FIGS. 1A-1B and the NG-RAN node shown in FIG. 2) directly or via a relay (e.g., the UE-to-Network relay shown in FIGS. 1A-1B and the UE-NW relay shown in FIG. 2).

According to the exemplary method 310 illustrated in FIG. 3A, the first terminal device may determine first information about whether to set up a connection (e.g. an RRC connection, etc.) over a direct path between the first terminal device and a target network node in a communication network, as shown in block 312. Then the first terminal device may transmit the first information towards a first network node via a second terminal device, as shown in block 314. In accordance with an exemplary embodiment, the target network node may be the first network node or a second network node different from the first network node in the communication network. For example, if a link between the first terminal device and the second network node has better quality than a link between the first terminal device and the first network node, the second network node may be determined as the target network node for the first terminal device.

In accordance with an exemplary embodiment, the first information may comprise a decision made by the first terminal device about whether to set up the connection over the direct path. In this case, the first terminal device may determine by itself whether to establish/resume the connection over the direct path, and inform the decision to the first network node via the second terminal device. According to an embodiment, the first information may indicate to set up the connection over the direct path between the first terminal device and the target network node.

In accordance with an exemplary embodiment, the first information may comprise one or more of:
first measurement information of the direct path between the first terminal device and the first network node;
second measurement information of a path between the first terminal device and the second terminal device; and
third measurement information of one or more direct paths between the first terminal device and one or more network nodes different from the first network node.

In accordance with an exemplary embodiment, the first information may be determined based at least in part on one or more of:
first measurement configuration information which may be generated by the first network node and transmitted to the first terminal device via the second terminal device;
second measurement configuration information which may be stored at the second terminal device and transmitted to the first terminal device; and
third measurement configuration information which may be generated by the second terminal device and transmitted to the first terminal device.

In accordance with an exemplary embodiment, the first terminal device may receive, from the first network node via the second terminal device, second information about whether the connection over the direct path is to be set up for the first terminal device. According to an exemplary embodiment, the second information may comprise a decision made by the first network node about whether the connection over the direct path is to be set up for the first terminal device. In this case, the first network node may determine whether the connection for the first terminal device can be established/resumed over the direct path, and inform the decision to the first terminal device via the second terminal device. In an embodiment, the second information may indicate to set up the connection over the direct path between the first terminal device and the target network node.

In accordance with an exemplary embodiment, the first information may be transmitted towards the first network node via the second terminal device, when the first terminal device has traffic towards the communication network. Alternatively or additionally, the first terminal device may transmit, to the first network node via the second terminal device, a notification that the first terminal device has traffic towards the communication network.

In accordance with an exemplary embodiment, the second terminal device may be operated in RRC connected mode according to one or more of:
an indication from the first terminal device to indicate that a message of the first terminal device needs to be relayed by the second terminal device;
a service being relayed to the communication network by the second terminal device; and
one or more terminal devices being linked with the second terminal device and having traffic towards the communication network.

In accordance with an exemplary embodiment, the first terminal device may receive, from the first network node via the second terminal device, configuration information (e.g., resource information, etc.) for setting up the connection over the direct path for the first terminal device. For example, the configuration information may include one or more parameters to indicate radio resource(s) to be used for uplink transmission of the first terminal device towards the target network node. According to an embodiment, the configuration information may include an RNTI (e.g., a C-RNTI, etc.) for the first terminal device over the direct path. According to another embodiment, the configuration information may indicate a contention free random access preamble and/or resource for the first terminal device over the direct path.

In accordance with an exemplary embodiment, the first terminal device may obtain an uplink grant configured to the first terminal device by the target network node, according to the configuration information. Based at least in part on the uplink grant, the first terminal device may set up the connection over the direct path between the first terminal device and the target network node.

In accordance with an exemplary embodiment, the first terminal device may perform contention free random access towards the target network node over the direct path, according to the configuration information. After accessing to the target network node, the first terminal device may set up the connection over the direct path between the first terminal device and the target network node.

In accordance with an exemplary embodiment, the configuration information may include an identifier of the target network node (e.g., when the target network node is the second network node which is not the serving network node of the second terminal device). According to an embodiment, the first terminal device may receive, from the first network node via the second terminal device, a parameter to indicate a validity period of the configuration information.

In accordance with an exemplary embodiment, the first terminal device may transmit a message to the second terminal device to release an indirect path between the first terminal device and the first network node via the second terminal device, in response to starting or finishing connection setup over the direct path between the first terminal device and the target network node.

In accordance with an exemplary embodiment, the first terminal device may have a service requiring latency lower than a threshold. For example, the first terminal device may have a delay sensitive service. In an exemplary embodiment, the first terminal device may be not in RRC connected mode (e.g., the first terminal device may be in RRC idle/inactive mode, etc.), before the connection over the direct path is set up for the first terminal device. According to an exemplary embodiment, the second terminal device may be able to support a L2 relaying capability and/or a L3 relaying capability.

FIG. 3B is a flowchart illustrating a method 320 according to some embodiments of the present disclosure. The method 320 illustrated in FIG. 3B may be performed by a second terminal device (e.g., the UE-to-Network relay shown in FIG. 1A and FIG. 1B, and the UE-NW relay shown in FIG. 2) or an apparatus communicatively coupled to the second terminal device. In accordance with an exemplary embodiment, the second terminal device may be configured to support D2D communication (e.g., V2X or SL communication, etc.) with other devices. In accordance with another exemplary embodiment, the second terminal device may be able to support a L2 relaying capability (e.g. acting as a L2 UE-to-NW relay UE) and/or a L3 relaying capability (e.g. acting as a L3 UE-to-NW relay UE). In an exemplary embodiment, the second terminal device may be configured to directly communicate with a network node (e.g., the gNB shown in FIGS. 1A-1B and the NG-RAN node shown in FIG. 2).

According to the exemplary method 320 illustrated in FIG. 3B, the second terminal device may receive first information from a first terminal device (e.g., the first terminal device as described with respect to FIG. 3A), as shown in block 322. The first information may be about whether to set up a connection over a direct path between the first terminal device and a target network node in a communication network. The second terminal device may transmit the first information to a first network node, as shown in block 324. In accordance with an exemplary embodiment, the target network node may be the first network node or a second network node different from the first network node in the communication network.

It can be appreciated that the steps, operations and related configurations of the method 320 illustrated in FIG. 3B may correspond to the steps, operations and related configurations of the method 310 illustrated in FIG. 3A. It also can be appreciated that the first information received by the second terminal device according to the method 320 may correspond to the first information transmitted by the first terminal device according to the method 310. Thus, the first information as described with respect to FIG. 3A and the first information as described with respect to FIG. 3B may have the same or similar contents and/or feature elements.

In accordance with an exemplary embodiment, the second terminal device may receive, from the first network node, second information about whether the connection over the direct path is to be set up for the first terminal device. Then the second terminal device may transmit the second information to the first terminal device.

It can be appreciated that the second information transmitted by the second terminal device according to the method 320 may correspond to the second information received by the first terminal device according to the method 310. Thus, the second information as described with respect to FIG. 3A and the second information as described with respect to FIG. 3B may have the same or similar contents and/or feature elements.

In accordance with an exemplary embodiment, the first information may be received from the first terminal device by the second terminal device, when the first terminal device has traffic towards the communication network.

In accordance with an exemplary embodiment, the second terminal device may receive, from the first terminal device, a notification that the first terminal device has traffic towards the communication network. Then the second terminal device may transmit the notification to the first network node.

In accordance with an exemplary embodiment, the second terminal device may receive, from the first network node, configuration information for setting up the connection over the direct path for the first terminal device. Then the second terminal device may transmit the configuration information to the first terminal device. In an embodiment, the second terminal device may receive, from the first network node, a parameter to indicate a validity period of the configuration information, and transmit the received parameter to the first terminal device.

It can be appreciated that the configuration information transmitted by the second terminal device according to the method 320 may correspond to the configuration information received by the first terminal device according to the method 310. Thus, the configuration information as described with respect to FIG. 3A and the configuration information as described with respect to FIG. 3B may have the same or similar contents and/or feature elements. According to the configuration information, the first terminal device may set up the connection over the direct path with the target network node, e.g., as described with respect to FIG. 3A.

In accordance with an exemplary embodiment, the second terminal device may receive a message from the first terminal device to release an indirect path between the first terminal device and the first network node via the second terminal device, when connection setup over the direct path between the first terminal device and the target network node is started or finished.

In accordance with an exemplary embodiment, the second terminal device may receive a first control message (e.g., an RRC message, etc.) from the first network node. The first control message may include an identifier of the first terminal device, e.g., a L2 ID of the first terminal device, a local ID determined for the first terminal device by the second terminal device, etc. The second terminal device may transmit the first control message to the first terminal device.

In accordance with an exemplary embodiment, the second terminal device may receive a second control message (e.g., an RRC message, etc.) from the first terminal device, and include an identifier of the first terminal device into the second control message, e.g., including a L2 ID of the first terminal device, a local ID determined for the first terminal device by the second terminal device, etc. Then the second terminal device may transmit the second control message including the identifier of the first terminal device to the first network node.

FIG. 3C is a flowchart illustrating a method 330 according to some embodiments of the present disclosure. The method 330 illustrated in FIG. 3C may be performed by a first network node (e.g., the gNB shown in FIGS. 1A-1B and the NG-RAN node shown in FIG. 2) or an apparatus communicatively coupled to the first network node. In accordance with an exemplary embodiment, the first network node may be configured to support cellular coverage extension with D2D communication (e.g., V2X or SL communication, etc.). In an exemplary embodiment, the first network node may be configured to communicate with a terminal device such as a UE, e.g. directly or via a relay.

According to the exemplary method 330 illustrated in FIG. 3C, the first network node may receive first information from a first terminal device (e.g., the first terminal device as described with respect to FIG. 3A) via a second terminal device (e.g., the second terminal device as described with respect to FIG. 3B), as shown in block 332. In accordance with an exemplary embodiment, the first information may be about whether to set up a connection over a direct path between the first terminal device and a target network node in a communication network. According to the first information, the first network node may determine whether the connection over the direct path is to be set up for the first terminal device, as shown in block 334. In accordance with an exemplary embodiment, the target network node may be the first network node or a second network node different from the first network node in the communication network.

It can be appreciated that the steps, operations and related configurations of the method 330 illustrated in FIG. 3C may correspond to the steps, operations and related configurations of the method 310 illustrated in FIG. 3A and/or the method 320 illustrated in FIG. 3B. It also can be appreciated that the first information received by the first network node via the second terminal device according to the method 330 may correspond to the first information transmitted by the first terminal device according to the method 310. Thus, the first information as described with respect to FIG. 3A and the first information as described with respect to FIG. 3C may have the same or similar contents and/or feature elements.

In accordance with an exemplary embodiment, the first network node may transmit, to the first terminal device via the second terminal device, second information about whether the connection over the direct path is to be set up for the first terminal device.

It can be appreciated that the second information transmitted by the first network node according to the method 330 may correspond to the second information received by the first terminal device according to the method 310. Thus, the second information as described with respect to FIG. 3A and the second information as described with respect to FIG. 3C may have the same or similar contents and/or feature elements.

In accordance with an exemplary embodiment, the first network node may receive the first information from the first terminal device via the second terminal device, when the first terminal device has traffic towards the communication network. Alternatively or additionally, the first network node may receive, from the first terminal device via the second terminal device, a notification that the first terminal device has traffic towards the communication network.

In accordance with an exemplary embodiment, the first network node may transmit, to the first terminal device via the second terminal device, configuration information for setting up the connection over the direct path for the first terminal device (e.g. the configuration information as described with respect to FIG. 3A). According to the configuration information, the first terminal device may set up the connection over the direct path with the target network node. In an embodiment, the first network node may transmit, to the first terminal device via the second terminal device, a parameter to indicate a validity period of the configuration information.

In accordance with an exemplary embodiment, the first network node may transmit a first control message (e.g., an RRC message) for the first terminal device to the second terminal device. The first control message may include an identifier of the first terminal device. Alternatively or additionally, the first network node may receive a second control message (e.g., an RRC message) for the first terminal device from the second terminal device. The second control message includes an identifier of the first terminal device.

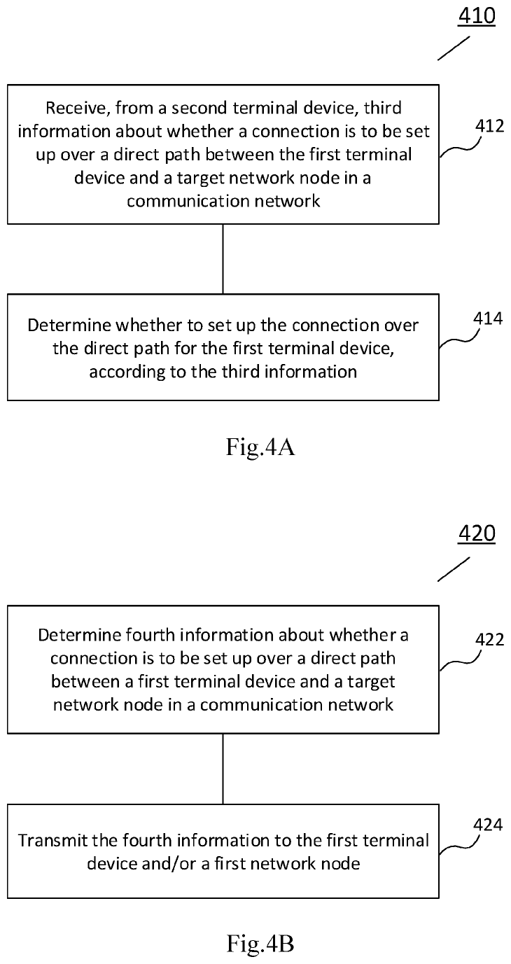

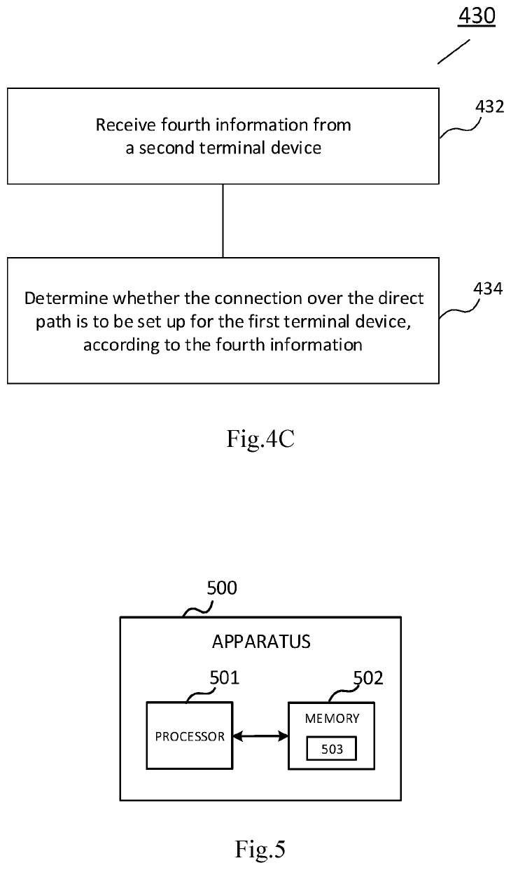

FIG. 4A is a flowchart illustrating a method 410 according to some embodiments of the present disclosure. The method 410 illustrated in FIG. 4A may be performed by a first terminal device (e.g., the remote UE shown in FIGS. 1A-1B and the UE shown in FIG. 2) or an apparatus communicatively coupled to the first terminal device. In accordance with an exemplary embodiment, the first terminal device may be configured to support D2D communication (e.g., V2X or SL communication, etc.) with other devices. In an exemplary embodiment, the first terminal device may be configured to communicate with a network node (e.g., the gNB shown in FIGS. 1A-1B and the NG-RAN node shown in FIG. 2) directly or via a relay (e.g., the UE-to-Network relay shown in FIGS. 1A-1B and the UE-NW relay shown in FIG. 2).

According to the exemplary method 410 illustrated in FIG. 4A, the first terminal device may receive from a second terminal device, third information about whether a connection is to be set up over a direct path between the first terminal device and a target network node in a communication network, as shown in block 412. According to the third information, the first terminal device may determine whether to set up the connection over the direct path for the first terminal device, as shown in block 414. In accordance with an exemplary embodiment, the target network node may be the first network node or a second network node different from the first network node in the communication network.

In accordance with an exemplary embodiment, the third information may comprise a decision made by the second terminal device about whether the connection over the direct path is set up for the first terminal device. In accordance with another exemplary embodiment, the third information may comprise a decision made by the first network node about whether the connection over the direct path is to be set up for the first terminal device. According to an embodiment, the third information (e.g., including the decision made by either the second terminal device or the first network node) may indicate to set up the connection over the direct path between the first terminal device and the target network node.

In accordance with an exemplary embodiment, the third information may be received from the second terminal device by the first terminal device, when the first terminal device has traffic towards the communication network. Alternatively or additionally, the first device may transmit, to the first network node via the second terminal device, a notification that the first terminal device has traffic towards the communication network.

In accordance with an exemplary embodiment, the first terminal device may receive, from the first network node via the second terminal device, configuration information (e.g., resource information, etc.) for setting up the connection over the direct path for the first terminal device. The configuration information may indicate the dedicated resource (e.g. by an RNTI such as C-RNTI, etc.) and/or a contention free random access preamble and/or resource for the first terminal device over the direct path, e.g., as described with respect to FIG. 3A. In an embodiment, the configuration information may include an identifier of the target network node. Optionally, there may be a validity period of the configuration information. In this case, the first terminal device may receive, from the first network node via the second terminal device, a parameter to indicate the validity period of the configuration information. According to the configuration information, the first terminal device may perform connection setup over the direct path with the target network node, e.g. as described with respect to FIG. 3A.

In accordance with an exemplary embodiment, the first terminal device may transmit a message to the second terminal device to release an indirect path between the first terminal device and the first network node via the second terminal device, in response to starting or finishing connection setup over the direct path between the first terminal device and the target network node.

In accordance with an exemplary embodiment, the first terminal device may have a service for which the latency needs to be lower than a threshold. Similar to the first terminal device as described with respect to FIG. 3A, the first terminal device as described with respect to FIG. 4A may be not in RRC connected mode before the connection over the direct path is set up for the first terminal device.

FIG. 4B is a flowchart illustrating a method 420 according to some embodiments of the present disclosure. The method 420 illustrated in FIG. 4B may be performed by a second terminal device (e.g., the UE-to-Network relay shown in FIG. 1A and FIG. 1B, and the UE-NW relay shown in FIG. 2) or an apparatus communicatively coupled to the second terminal device. In accordance with an exemplary embodiment, the second terminal device may be configured to support D2D communication (e.g., V2X or SL communication, etc.) with other devices. In accordance with another exemplary embodiment, the second terminal device may be able to support a L2 relaying capability and/or a L3 relaying capability. In an exemplary embodiment, the second terminal device may be configured to directly communicate with a network node (e.g., the gNB shown in FIGS. 1A-1B and the NG-RAN node shown in FIG. 2).

According to the exemplary method 420 illustrated in FIG. 4B, the second terminal device may determine fourth information about whether a connection is to be set up over a direct path between a first terminal device (e.g., the first terminal device as described with respect to FIG. 4A) and a target network node in a communication network, as shown in block 422. Then the second terminal device may transmit the fourth information to the first terminal device and/or a first network node, as shown in block 424. In accordance with an exemplary embodiment, the target network node may be the first network node or a second network node different from the first network node in the communication network.

In accordance with an exemplary embodiment, the fourth information may comprise a decision made by the second terminal device about whether the connection over the direct path is to be set up for the first terminal device. In this case, the second terminal device may determine whether the connection for the first terminal device may be established/resumed over the direct path, and inform the decision to the first network node and/or the first terminal device. According to an embodiment, the fourth information may indicate to set up the connection over the direct path between the first terminal device and the target network node.

In accordance with an exemplary embodiment, the fourth information may comprise: third measurement information of a path between the second terminal device and the first network node, and/or fourth measurement information of a path between the first terminal device and the second terminal device. In this case, the second terminal device may not determine whether the connection for the first terminal device may be established/resumed over the direct path, but measure link quality of the second terminal device and send the measurement results to e.g. the first network node, so that the first network node can make the decision on whether the connection for the first terminal device may be established/resumed over the direct path.

In accordance with an exemplary embodiment, the second terminal device may receive, from the first network node, fifth information about whether the connection over the direct path is to be set up for the first terminal device. Then the second terminal device may transmit the fifth information to the first terminal device. The fifth information may comprise a decision made by the first network node about whether the connection over the direct path is to be set up for the first terminal device. In an embodiment, the fifth information may indicate to set up the connection over the direct path between the first terminal device and the target network node.

In accordance with an exemplary embodiment, the second terminal device may transmit the fourth information to the first terminal device and/or the first network node, when the first terminal device has traffic towards the communication network. Alternatively or additionally, the second terminal device may receive, from the first terminal device, a notification that the first terminal device has traffic towards the communication network. Then the second terminal device may transmit the notification to the first network node.

It can be appreciated that the steps, operations and related configurations of the method 420 illustrated in FIG. 4B may correspond to the steps, operations and related configurations of the method 410 illustrated in FIG. 4A. It also can be appreciated that in some embodiments, the fourth information transmitted to the first terminal device by the second terminal device according to the method 420 may correspond to the third information received from the second terminal device by the first terminal device according to the method 410. Thus, the third information as described with respect to FIG. 4A and the fourth information as described with respect to FIG. 4B may have the same or similar contents and/or feature elements.

Similarly, it can be appreciated that in some embodiments, the fifth information transmitted to the first terminal device by the second terminal device according to the method 420 may correspond to the third information received from the second terminal device by the first terminal device according to the method 410. Thus, the third information as described with respect to FIG. 4A and the fifth information as described with respect to FIG. 4B may have the same or similar contents and/or feature elements.

In accordance with an exemplary embodiment, the second terminal device may receive, from the first network node, configuration information for setting up the connection over the direct path for the first terminal device. Then the second terminal device may transmit the configuration information to the first terminal device. In an embodiment, the second terminal device may receive, from the first network node, a parameter to indicate a validity period of the configuration information. Then the second terminal device may transmit the received parameter to the first terminal device.

In accordance with an exemplary embodiment, the second terminal device may receive a message from the first terminal device to release an indirect path between the first terminal device and the first network node via the second terminal device, when connection setup over the direct path between the first terminal device and the target network node is started or finished.

In accordance with an exemplary embodiment, the second terminal device may receive a third control message from the first network node. The third control message may include an identifier of the first terminal device. Then the second terminal device may transmit the third control message to the first terminal device. Alternatively or additionally, the second terminal device may receive a fourth control message from the first terminal device, and include an identifier of the first terminal device into the fourth control message. Then the second terminal device may transmit the fourth control message including the identifier of the first terminal device to the first network node.

In accordance with an exemplary embodiment, the second terminal device may be operated in RRC connected mode for different cases, e.g., as described with respect to FIG. 3A. For example, the first terminal device may inform the second terminal device to set up an RRC connection in advance. Alternatively or additionally, the second terminal device may be kept in RRC connected mode by the communication network, e.g. according to the service type and/or QoS requirement of a service which is (to be) relayed by the second terminal device. Alternatively or additionally, the second terminal device may be operated in RRC connected mode if any of the linked terminal devices has traffic being sent to the communication network.

FIG. 4C is a flowchart illustrating a method 430 according to some embodiments of the present disclosure. The method 430 illustrated in FIG. 4C may be performed by a first network node (e.g., the gNB shown in FIGS. 1A-1B and the NG-RAN node shown in FIG. 2) or an apparatus communicatively coupled to the first network node. In accordance with an exemplary embodiment, the first network node may be configured to support cellular coverage extension with D2D communication (e.g., V2X or SL communication, etc.). In an exemplary embodiment, the first network node may be configured to communicate with a terminal device such as a UE, e.g. directly or via a relay.

According to the exemplary method 430 illustrated in FIG. 4C, the first network node may receive fourth information from a second terminal device (e.g., the second terminal device as described with respect to FIG. 4B), as shown in block 432. The fourth information may be about whether a connection is to be set up over a direct path between a first terminal device (e.g., the first terminal device as described with respect to FIG. 4A) and a target network node in a communication network. According to the fourth information, the first network node may determine whether the connection over the direct path is to be set up for the first terminal device, as shown in block 434. In accordance with an exemplary embodiment, the target network node may be the first network node or a second network node different from the first network node in the communication network.

It can be appreciated that the steps, operations and related configurations of the method 430 illustrated in FIG. 4C may correspond to the steps, operations and related configurations of the method 420 illustrated in FIG. 4B. It also can be appreciated that the fourth information received by the first network node according to the method 430 may correspond to the fourth information transmitted by the second terminal device according to the method 420. Thus, the fourth information as described with respect to FIG. 4B and the fourth information as described with respect to FIG. 4C may have the same or similar contents and/or feature elements.

In accordance with an exemplary embodiment, the first network node may transmit, to the first terminal device via the second terminal device, fifth information about whether the connection over the direct path is to be set up for the first terminal device. It also can be appreciated that the fifth information transmitted by the first network node according to the method 430 may correspond to the fifth information received by the second terminal device according to the method 420. Thus, the fifth information as described with respect to FIG. 4B and the fifth information as described with respect to FIG. 4C may have the same or similar contents and/or feature elements.

In accordance with an exemplary embodiment, the first network node may receive the fourth information from the second terminal device, when the first terminal device has traffic towards the communication network. Alternatively or additionally, the first network node may receive, from the first terminal device via the second terminal device, a notification that the first terminal device has traffic towards the communication network.

In accordance with an exemplary embodiment, the first network node may transmit, to the first terminal device via the second terminal device, configuration information for setting up the connection over the direct path for the first terminal device. Optionally, the first network node may transmit, to the first terminal device via the second terminal device, a parameter to indicate a validity period of the configuration information. It can be appreciated that the configuration information described with respect to FIGS. 4A-4C and the configuration information described with respect to FIGS. 3A-3C may have the same or similar contents and/or feature elements.

In accordance with an exemplary embodiment, the first network node may transmit a third control message for the first terminal device to the second terminal device. The third control message may include an identifier of the first terminal device. Alternatively or additionally, the first network node may receive a fourth control message for the first terminal device from the second terminal device. The fourth control message may include an identifier of the first terminal device.

It can be appreciated that the first terminal device as described with respect to FIG. 4A may be configured to perform the method 310 as described with respect to FIG. 3A, for example, according to different network configurations and/or capabilities of the first terminal device. Correspondingly, the first terminal device as described with respect to FIG. 3A may also be configured to perform the method 410 as described with respect to FIG. 4A. Similarly, the second terminal device as described with respect to FIG. 4B may also be configured to perform the method 320 as described with respect to FIG. 3B, the second terminal device as described with respect to FIG. 3B may also be configured to perform the method 420 as described with respect to FIG. 4B, the first network node as described with respect to FIG. 4C may also be configured to perform the method 330 as described with respect to FIG. 3C, and the first network node as described with respect to FIG. 3C may also be configured to perform the method 430 as described with respect to FIG. 4C.

Various exemplary embodiments according to the present disclosure may enable a remote UE that is currently not in RRC connected mode to set up an RRC connection over a direct path more quickly. For example, if link quality of the direct path is good enough, with the presence of a UE-to-NW relay UE, the remote UE not in RRC connected mode may establish/resume the RRC connection over the direct path, e.g., by performing contention free random access or even without performing a random access procedure while using the UL grant according to the C-RNTI for the remote UE. Application of various exemplary embodiments can support fast connection establishment/resumption for a UE with help of a UE-to-NW relay, so as to enhance service performance with reduced latency.

The various blocks shown in FIGS. 3A-3C and FIGS. 4A-4C may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 5 is a block diagram illustrating an apparatus 500 according to various embodiments of the present disclosure. As shown in FIG. 5, the apparatus 500 may comprise one or more processors such as processor 501 and one or more memories such as memory 502 storing computer program codes 503. The memory 502 may be non-transitory machine/processor/computer readable storage medium. In accordance with some exemplary embodiments, the apparatus 500 may be implemented as an integrated circuit chip or module that can be plugged or installed into a first terminal device as described with respect to FIG. 3A or FIG. 4A, a second terminal device as described with respect to FIG. 3B or FIG. 4B, or a first network node as described with respect to FIG. 3C or FIG. 4C. In such cases, the apparatus 500 may be implemented as a first terminal device as described with respect to FIG. 3A or FIG. 4A, a second terminal device as described with respect to FIG. 3B or FIG. 4B, or a first network node as described with respect to FIG. 3C or FIG. 4C.

In some implementations, the one or more memories 502 and the computer program codes 503 may be configured to, with the one or more processors 501, cause the apparatus 500 at least to perform any operation of the method as described in connection with FIG. 3A. In other implementations, the one or more memories 502 and the computer program codes 503 may be configured to, with the one or more processors 501, cause the apparatus 500 at least to perform any operation of the method as described in connection with FIG. 3B. In other implementations, the one or more memories 502 and the computer program codes 503 may be configured to, with the one or more processors 501, cause the apparatus 500 at least to perform any operation of the method as described in connection with FIG. 3C. In other implementations, the one or more memories 502 and the computer program codes 503 may be configured to, with the one or more processors 501, cause the apparatus 500 at least to perform any operation of the method as described in connection with FIG. 4A. In other implementations, the one or more memories 502 and the computer program codes 503 may be configured to, with the one or more processors 501, cause the apparatus 500 at least to perform any operation of the method as described in connection with FIG. 4B. In other implementations, the one or more memories 502 and the computer program codes 503 may be configured to, with the one or more processors 501, cause the apparatus 500 at least to perform any operation of the method as described in connection with FIG. 4C. Alternatively or additionally, the one or more memories 502 and the computer program codes 503 may be configured to, with the one or more processors 501, cause the apparatus 500 at least to perform more or less operations to implement the proposed methods according to the exemplary embodiments of the present disclosure.

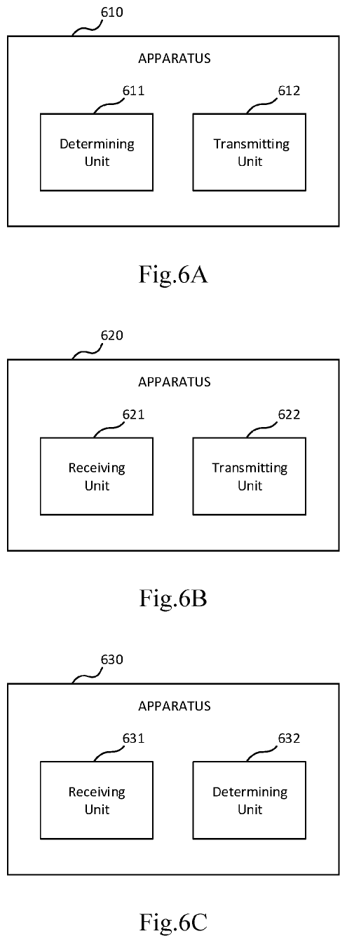

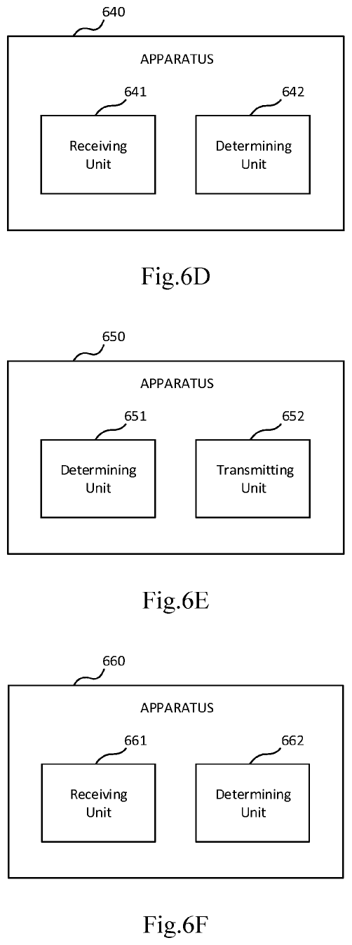

FIG. 6A is a block diagram illustrating an apparatus 610 according to some embodiments of the present disclosure. As shown in FIG. 6A, the apparatus 610 may comprise a determining unit 611 and a transmitting unit 612. In an exemplary embodiment, the apparatus 610 may be implemented in a first terminal device such as a UE. The determining unit 611 may be operable to carry out the operation in block 312, and the transmitting unit 612 may be operable to carry out the operation in block 314. Optionally, the determining unit 611 and/or the transmitting unit 612 may be operable to carry out more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise a receiving unit 621 and a transmitting unit 622. In an exemplary embodiment, the apparatus 620 may be implemented in a second terminal device such as a UE. The receiving unit 621 may be operable to carry out the operation in block 322, and the transmitting unit 622 may be operable to carry out the operation in block 324. Optionally, the receiving unit 621 and/or the transmitting unit 622 may be operable to carry out more or less operations to implement the proposed methods according to the exemplary embodiments of the present disclosure.

FIG. 6C is a block diagram illustrating an apparatus 630 according to some embodiments of the present disclosure. As shown in FIG. 6C, the apparatus 630 may comprise a receiving unit 631 and a determining unit 632. In an exemplary embodiment, the apparatus 630 may be implemented in a first network node such as a base station. The receiving unit 631 may be operable to carry out the operation in block 332, and the determining unit 632 may be operable to carry out the operation in block 334. Optionally, the receiving unit 631 and/or the determining unit 632 may be operable to carry out more or less operations to implement the proposed methods according to the exemplary embodiments of the present disclosure.

FIG. 6D is a block diagram illustrating an apparatus 640 according to some embodiments of the present disclosure. As shown in FIG. 6D, the apparatus 640 may comprise a receiving unit 641 and a determining unit 642. In an exemplary embodiment, the apparatus 640 may be implemented in a first terminal device such as a UE. The receiving unit 641 may be operable to carry out the operation in block 412, and the determining unit 642 may be operable to carry out the operation in block 414. Optionally, the receiving unit 641 and/or the determining unit 642 may be operable to carry out more or less operations to implement the proposed methods according to the exemplary embodiments of the present disclosure.

FIG. 6E is a block diagram illustrating an apparatus 650 according to some embodiments of the present disclosure. As shown in FIG. 6E, the apparatus 650 may comprise a determining unit 651 and a transmitting unit 652. In an exemplary embodiment, the apparatus 650 may be implemented in a second terminal device such as a UE. The determining unit 651 may be operable to carry out the operation in block 422, and the transmitting unit 652 may be operable to carry out the operation in block 424. Optionally, the determining unit 651 and/or the transmitting unit 652 may be operable to carry out more or less operations to implement the proposed methods according to the exemplary embodiments of the present disclosure.

FIG. 6F is a block diagram illustrating an apparatus 660 according to some embodiments of the present disclosure. As shown in FIG. 6F, the apparatus 660 may comprise a receiving unit 661 and a determining unit 662. In an exemplary embodiment, the apparatus 660 may be implemented in a first network node such as a base station. The receiving unit 661 may be operable to carry out the operation in block 432, and the determining unit 662 may be operable to carry out the operation in block 434. Optionally, the receiving unit 661 and/or the determining unit 662 may be operable to carry out more or less operations to implement the proposed methods according to the exemplary embodiments of the present disclosure.

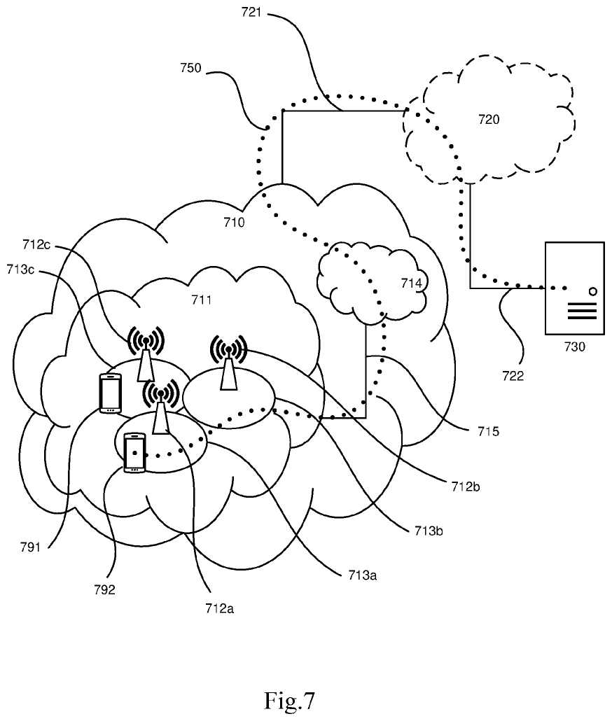

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

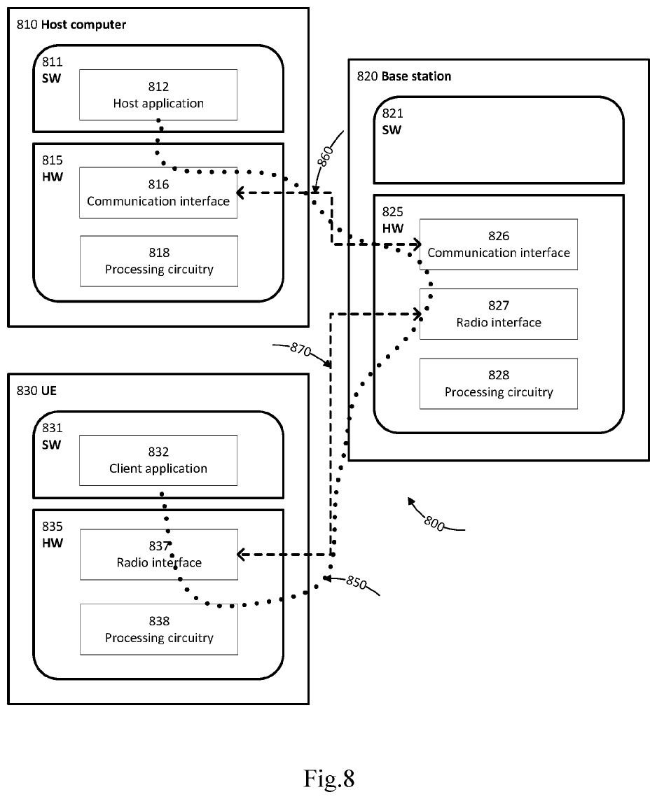

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

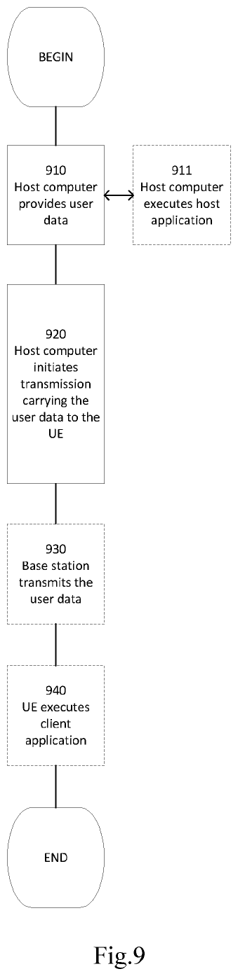

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

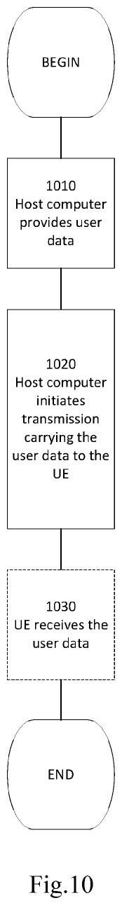

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

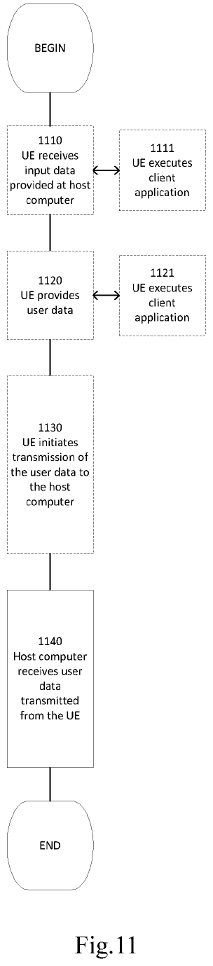

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

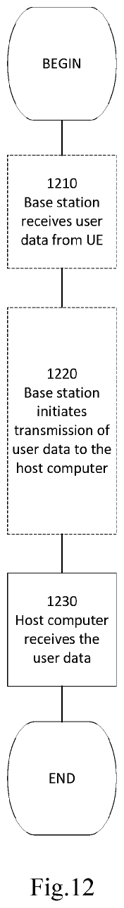

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 330 as describe with respect to FIG. 3C, or any step of the exemplary method 430 as describe with respect to FIG. 4C.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 330 as describe with respect to FIG. 3C, or any step of the exemplary method 430 as describe with respect to FIG. 4C.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 310 as describe with respect to FIG. 3A, or any step of the exemplary method 320 as describe with respect to FIG. 3B, or any step of the exemplary method 410 as describe with respect to FIG. 4A, or any step of the exemplary method 420 as describe with respect to FIG. 4B.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 310 as describe with respect to FIG. 3A, or any step of the exemplary method 320 as describe with respect to FIG. 3B, or any step of the exemplary method 410 as describe with respect to FIG. 4A, or any step of the exemplary method 420 as describe with respect to FIG. 4B.

According to some exemplary embodiments, there is provided a method implemented in a communication system which may include a host computer, a base station and a UE. The method may comprise, at the host computer, receiving user data transmitted to the base station from the UE which may perform any step of the exemplary method 310 as describe with respect to FIG. 3A, or any step of the exemplary method 320 as describe with respect to FIG. 3B, or any step of the exemplary method 410 as describe with respect to FIG. 4A, or any step of the exemplary method 420 as describe with respect to FIG. 4B.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 310 as describe with respect to FIG. 3A, or any step of the exemplary method 320 as describe with respect to FIG. 3B, or any step of the exemplary method 410 as describe with respect to FIG. 4A, or any step of the exemplary method 420 as describe with respect to FIG. 4B.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 330 as describe with respect to FIG. 3C, or any step of the exemplary method 430 as describe with respect to FIG. 4C.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 330 as describe with respect to FIG. 3C, or any step of the exemplary method 430 as describe with respect to FIG. 4C.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a first terminal device, comprising:
determining first information about whether to set up a connection over a direct path between the first terminal device and a target network node in a communication network; and
transmitting the first information towards a first network node via a second terminal device, wherein the target network node is the first network node or a second network node different from the first network node in the communication network.

2. (canceled)

3. The method of claim 1, wherein the first information indicates to set up the connection over the direct path between the first terminal device and the target network node.

4. The method of claim 1, wherein the first information comprises:
first measurement information of the direct path between the first terminal device and the first network node;
second measurement information of a path between the first terminal device and the second terminal device; and/or
third measurement information of one or more direct paths between the first terminal device and one or more network nodes different from the first network node.

5. The method of claim 4, wherein the first information is determined based at least in part on one or more of:
first measurement configuration information which is generated by the first network node and transmitted to the first terminal device via the second terminal device;
second measurement configuration information which is stored at the second terminal device and transmitted to the first terminal device; or
third measurement configuration information which is generated by the second terminal device and transmitted to the first terminal device.

6. The method of claim 4, further comprising:
receiving, from the first network node via the second terminal device, second information about whether the connection over the direct path is to be set up for the first terminal device.

7. The method of claim 6, wherein the second information comprises a decision made by the first network node about whether the connection over the direct path is to be set up for the first terminal device.

8. The method of claim 6, wherein the second information indicates to set up the connection over the direct path between the first terminal device and the target network node.

9. The method of claim 1, wherein the first information is transmitted towards the first network node via the second terminal device, when the first terminal device has traffic towards the communication network.

10. The method of claim 1, further comprising:
transmitting, to the first network node via the second terminal device, a notification that the first terminal device has traffic towards the communication network.

11. The method of claim 1, wherein the second terminal device is operated in radio resource control connected mode according to one or more of:
an indication from the first terminal device to indicate that a message of the first terminal device needs to be relayed by the second terminal device;
a service being relayed to the communication network by the second terminal device; and
one or more terminal devices being linked with the second terminal device and having traffic towards the communication network.

12. The method of claim 3, further comprising:
receiving, from the first network node via the second terminal device, configuration information for setting up the connection over the direct path for the first terminal device.

13. The method of claim 12, wherein the configuration information includes a radio network temporary identity for the first terminal device over the direct path.

14. The method of claim 12, further comprising:
obtaining an uplink grant configured to the first terminal device by the target network node, according to the configuration information; and
setting up the connection over the direct path between the first terminal device and the target network node, based at least in part on the uplink grant.

15. The method of claim 12, wherein the configuration information indicates a contention free random access preamble and/or resource for the first terminal device over the direct path.

16. The method of claim 12, further comprising:
performing contention free random access towards the target network node over the direct path, according to the configuration information; and
setting up the connection over the direct path between the first terminal device and the target network node, after accessing to the target network node.

17. (canceled)

18. The method of claim 12, further comprising:
receiving, from the first network node via the second terminal device, a parameter to indicate a validity period of the configuration information.

19. The method of claim 12, further comprising:
transmitting a message to the second terminal device to release an indirect path between the first terminal device and the first network node via the second terminal device, in response to starting or finishing connection setup over the direct path between the first terminal device and the target network node.

20. The method of claim 1, wherein the first terminal device has a service requiring latency lower than a threshold.

21. The method of claim 1, wherein the first terminal device is not in radio resource control connected mode before the connection over the direct path is set up for the first terminal device.

22. (canceled)

23. A first terminal device, comprising:
one or more processors; and
one or more memories comprising computer program codes,
the one or more memories and the computer program codes configured to, with the one or more processors, cause the first terminal device at least to:
determine first information about whether to set up a connection over a direct path between the first terminal device and a target network node in a communication network; and
transmit the first information towards a first network node via a second terminal device, wherein the target network node is the first network node or a second network node different from the first network node in the communication network.

24-140. (canceled)
